(19) United States
(12) Patent Application Publication
(10) Pub. No.: US 2014/0096752 A1
(43) Pub. Date: Apr. 10, 2014

(54) EXHAUST GAS SUPPLY PIPE FOR EGR COOLER OF VEHICLE

(71) Applicants: HYUNDAI MOTOR COMPANY, Seoul (KR); KIA MOTORS CORPORATION, Seoul (KR)

(72) Inventor: Jeong Hyun NA, Hwaseong-si (KR)

(73) Assignees: Kia Motors Corporation, Seoul (KR); Hyundai Motor Company, Seoul (KR)

(21) Appl. No.: 13/718,075

(22) Filed: Dec. 18, 2012

(30) Foreign Application Priority Data
Oct. 9, 2012 (KR) 10-2012-0111673

(51) Int. Cl. F02M 25/07

(52) U.S. Cl. CPC F02M 25/0726
USPC 123/568.12

(57) ABSTRACT

Disclosed is an exhaust gas supply pipe for an EGR cooler of a vehicle, and more particularly, to an exhaust gas supply pipe for an EGR cooler of a vehicle, which is capable of improving an initial mounted state through a bellows and also of preventing damage caused by high exhaust heat. To this end, the present invention provides an exhaust gas supply pipe for an EGR cooler of a vehicle, including: a left pipe connected to an exhaust manifold of an engine; a right pipe connected to an EGR cooler; a bellows connecting the left pipe and the right pipe to each other and disposed at an outer periphery of the left pipe; and a heat blocking material filled in a space between the outer periphery of the left pipe and an inner periphery of the bellows.

### CROSS-REFERENCE TO RELATED APPLICATIONS

The present application claims priority of Korean Patent Application Number 10-2012-0111673 filed Oct. 9, 2012, the entire contents of which application is incorporated herein for all purposes by this reference.

### BACKGROUND OF INVENTION

1. Field of Invention

The present invention relates to an exhaust gas supply pipe for an EGR cooler of a vehicle, and more particularly, to an exhaust gas supply pipe for an EGR cooler of a vehicle, which is capable of improving an initial mounted state through a bellows and also of preventing damage caused by high exhaust heat.

2. Description of Related Art

Many technologies for reducing exhaust gas emissions such as nitrogen oxide have been developed according to exhaust gas emissions regulations for vehicles. One of the methods employed in these technologies is Exhaust Gas Recirculation (hereinafter called EGR) which can reduce the amount of emissions such as NO_{X} included in exhaust gas by recirculating a portion of the exhaust gas to the intake unit.

Here, referring to the attached FIG. 1 which appended, a description will be provided of a typical structure of a pipe for supplying exhaust gas for an EGR cooler.

When recirculating exhaust gas exhausted from an engine to an intake unit, the exhaust gas is of a high temperature, which requires that the high temperature exhaust gas be cooled. An EGR cooler 12 of the type that circulates coolant is mounted on an exhaust gas recirculation line to cool the exhaust gas.

Here, the exhaust gas supply pipe 12 for an EGR cooler is connected between an exhaust manifold 10 and an EGR cooler 14 of the engine in order to supply a portion of the exhaust gas exhausted from the exhaust manifold 10 to the EGR cooler 14.

The exhaust gas supply pipe 12 for an EGR cooler has one end connected to the engine exhaust manifold 10 side and the other end connected to the EGR cooler 14 inlet side, and functions to send a portion of the exhaust gas exhausted from the engine exhaust manifold 10 to the EGR cooler 14.

The exhaust gas supply pipe 12 that is thus connected between the EGR cooler 14 and the exhaust manifold 10, at the front end of the EGR cooler, is an essential component for engine durability because the exhaust gas supply pipe 12 performs the function of introducing a portion of the exhaust gas as cooled EGR gas into a combustion chamber and lowering the combustion heat of the engine.

If the introduction of the EGR gas is blocked to the engine combustion chamber, the combustion heat will increase to a level in which the durability of each component will be surpassed, which may cause engine failure. Accordingly, while the exhaust gas supply pipe performs the function of relaying a portion of exhaust gas from the exhaust manifold to the EGR cooler—that is, of simply acting as a passage for the exhaust gas, if the component of the exhaust gas supply pipe connecting the EGR cooler and the exhaust manifold were not present, this could lead to a serious problem such as engine failure.

Because the exhaust gas supply pipe for an EGR cooler that performs such an important function has one end connected to the EGR cooler as described above and has engine vibration relayed from the EGR cooler, and has the other end connected to the exhaust manifold, so that high temperature exhaust gas passes therethrough, the exhaust gas supply pipe is directly exposed to high temperatures of about 850° C.

In particular, a related art exhaust gas supply pipe employs a bellows in consideration of passage flow and to improve an initial mounted state, and is intended to minimize expansion from the high temperature of the exhaust gas.

However, as a Euro-6 Q-CNG engine was designed to be switched from the existing lean burn combustion method to the stoichiometric combustion method, exhaust gas temperature levels rose from 700° C. to 850° C. or higher, rendering such development very difficult and the design to be manifested directly in the exhaust gas supply pipe.

Specifically, as illustrated in FIG. 2, the exhaust gas supply pipe 12 is a type applied to the diesel engine Euro-5 that has already been mass produced, and the exhaust gas supply pipe is subject to the problem of cracks forming from being unable to handle a large increase in the exhaust gas temperature.

Further, in order to prevent exhaust gas heat from being diffused from a related art exhaust gas supply pipe 12 to the surrounding components, the exhaust gas supply pipe 12 needs to have a separate heat resistant cover 16 mounted thereon.

In addition, while the bellows applied to the related art exhaust gas supply pipe are intended to provide the function of flexibility to cover the relative positions of two components, and reduce relative displacement by absorbing thermal expansion from high temperatures, the bellows have the drawback of easily deforming when high temperature exhaust gas comes into direct contact therewith.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an exhaust gas supply pipe for an EGR cooler of a vehicle which has a left pipe and a right pipe that are fastened to be mutually slidable, has a bellows pipe installed on the outer periphery thereof, and has a heat blocking fiber filled in a space between the outer periphery of the left pipe and the inner periphery of the bellows, so that flexibility may be provided by the bellows, while an initial mounted state may be improved, and high temperature exhaust gas may be easily prevented from being diffused to the outside by means of the heat blocking fiber, without a separate heat resistant cover.

Various aspects of the present invention provide for an exhaust gas supply pipe for an EGR cooler of a vehicle, including: a left pipe connected to an exhaust manifold of an engine; a right pipe connected to an EGR cooler; a bellows connecting the left pipe and the right pipe to each other and disposed at an outer peripheral portion of the left pipe; and a heat blocking material filled in a space between the outer peripheral portion of the left pipe and an inner peripheral portion of the bellows.

The heat blocking material may be adopted as a heat blocking fiber made of silica.

Further, a rear end of the outer peripheral portion of the left pipe and a front end of an outer peripheral portion of the right pipe may include a fastening end projecting therefrom over which both ends of the bellows are placed, respectively, and fastened by a clamp.

In addition, a step may be formed in a front end of the inner peripheral portion of the right pipe such that a front end of the left pipe is slid and inserted therein.

Through the means for solving the above problems, the present invention provides the following effects.

According to various aspects of the present invention, it is possible to configure an exhaust gas supply pipe for an EGR with a left pipe and a right pipe that are fastened to be capable of mutually sliding, while mounting a bellows pipe on the outer peripheries thereof, in order to impart flexibility through the bellows and also improve an initial mounted state; and in particular, by filling a heat blocking fiber between the outer periphery of the left pipe and an inner periphery of the bellows, heat from high temperature exhaust gas can easily be prevented from being diffused to the outside without a separate heat dissipation cover.

Further, by preventing high temperature exhaust heat from diffusing to the outside (toward the bellows) by means of the heat blocking material, the forming of cracks on the bellows due to the high temperature exhaust heat may be prevented without the existing heat dissipation cover, and as a result, because the bellows are not exposed to high temperatures, a reduction in strength of the bellows may be prevented.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are schematic views illustrating an exhaust gas supply pipe for a related art of EGR.

FIGS. 3 and 4 are schematic views illustrating an exemplary exhaust gas supply pipe for an EGR according to the present invention.

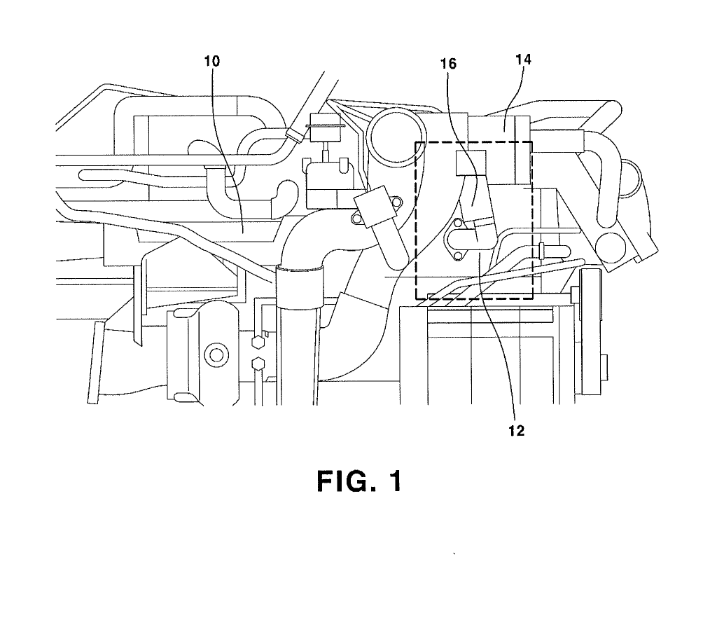

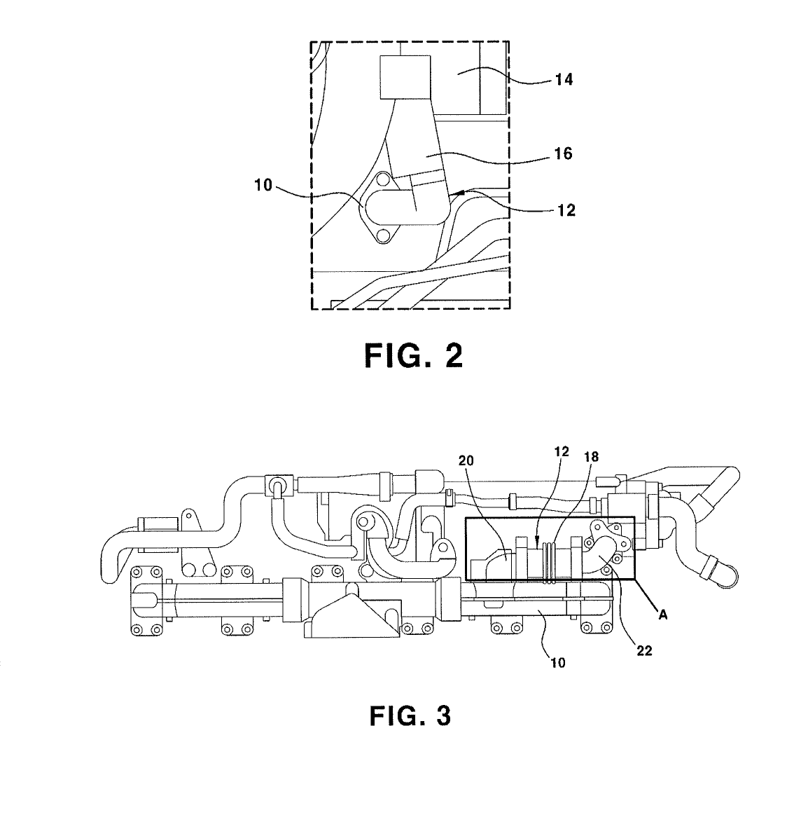

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exhaust gas supply pipe for EGR according to various embodiments of the present invention primarily blocks high heat with a primary heat resistant pipe including a left pipe and a right pipe, and secondarily blocks the high heat from exhaust gas by means of a heat blocking material filled on the outer peripheral portion of the primary heat resistant pipe, so as to completely prevent a breakage phenomenon such as the formations of cracks in the bellows disposed on the outer peripheral portion of the heat resistant material while connecting the left pipe with the right pipe, and disposed on the outer peripheral portion of the heat resistant material.

Referring to the attached FIG. 3, an exhaust gas supply pipe 12 for an EGR cooler is connected between the exhaust manifold 10 of the engine and the EGR cooler 14, in order to supply a portion of the exhaust gas exhausted from the exhaust manifold 10 to the EGR cooler 14.

The exhaust gas supply pipe 12 for an EGR cooler according to various embodiments of the present invention includes a left pipe 20 connected to the exhaust manifold 10 of the engine, a right pipe 22 connected to the EGR cooler 14, and a bellows 18 connecting the left pipe 20 and the right pipe 22 to each other and disposed at the outer peripheral portion of the left pipe 20.

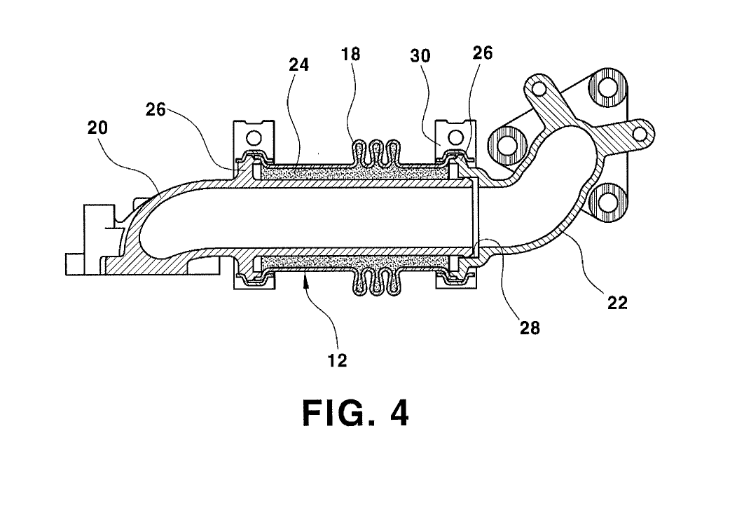

In particular, as illustrated in the attached FIG. 4, a heat blocking material 24 is filled in a space between the outer peripheral portion of the left pipe 20 connected to the exhaust manifold 10 of the engine, and the inner peripheral portion of the bellows 18, in order to prevent the high heat from the exhaust gas passing through the left pipe 20 from being diffused to the outside.

The heat blocking material 24 may be adopted from a heat blocking fiber made from a silica material, and may also be made of any other material that can block the diffusion of heat.

While in the past, an exhaust manifold 10 of an engine and an EGR cooler 14 were simply connected in a single pipe type bellows shape, with the outer peripheral portion of the bellows being shielded by the heat resistant cover, in various embodiments of the present invention, the portion connecting the exhaust manifold 10 and the EGR cooler 14 is characterized by being formed of the left pipe 20 and the right pipe 22 for primarily blocking the high heat from exhaust gas.

The left pipe 20 is connected to the exhaust manifold 10 of the engine, the right pipe 22 is connected to the EGR cooler 14, and the left pipe 20 and the right pipe 22 are fastened to be mutually slidable.

To this end, a shoulder or step 28 is formed at the front end of the inner peripheral portion of the right pipe 22 in order for the front end of the left pipe 20 to be slid and inserted therein.

Accordingly, the front end of the left pipe 20 connected to the exhaust manifold 10 is detachably inserted and fastened in the step 28 of the right pipe 22 connected to the EGR cooler 14, and when the exhaust gas flowing through the EGR cooler 14 from the exhaust manifold 10 passes through the left pipe 20 and the right pipe 22, the high heat from the exhaust gas is primarily blocked from being diffused to the outside at the first left pipe 20 and the second right pipe 22.

Here, the bellows 18 is disposed at the outer peripheral portion of the left pipe 20, and both ends of the bellows 18 are assembled by being pressed and fixed to fixing steps 26 that are integrally formed to project on the rear end of the outer peripheral portion of the left pipe 20 and the front end of the outer peripheral portion of the right pipe 22.

That is, both ends of the bellows 18 are first pressed against the fixing steps or flange 26 formed to integrally protrude at the rear end of the outer peripheral portion of the left pipe 20 and the front end of the outer peripheral portion of the right pipe 22, and then the pressed areas are tightened by a clamp 30 to complete the assembly of the bellows 18. One will appreciate that the steps may be monolithically formed with the pipes.

Of course, the bellows 18 provide flexibility during initial mounting and assembly of the exhaust gas supply pipe for EGR including the left pipe 20 and the right pipe 22, through a sliding movement which inserts the left pipe 20 more toward the right pipe 22 or withdraws the left pipe 20 from the right pipe 22, and also reduces tolerance to enable smooth assembly.

According to various embodiments of the present invention, as a heat blocking material 24 for preventing high heat from exhaust gas passing through the left pipe 20 between the outer peripheral portion of the left pipe 20 and the inner peripheral portion of the bellows 18, from diffusing to the outside, the heat blocking material 24 is filled with a heat blocking fiber formed of silica material, and performs the function of secondarily blocking high heat from exhaust gas passing through the inside of the left pipe 20 from being diffused to the outside.

Thus, while a related art bellows pipe performs the functions of providing flexibility (tolerance absorption) upon being mounted and reducing deformation under high temperatures, high heat from exhaust gas directly comes into contact therewith, and a separate heat resistant cover is mounted thereon, in various embodiments of the present invention, thermal durability is obtained through an exhaust pipe (left pipe and right pipe) having durability, and a heat blocking material is introduced between each exhaust pipe and the bellows, so that heat transferred to the bellows is fundamentally blocked to prevent a deterioration in the thermal properties of a bellows pipe and improved durability thereof is promoted.

That is, while a bellows pipe of an SUS material has the problem of being unable to retain durability due to oxidation when exposed to high temperatures, in exemplary embodiments of the present invention, high heat from exhaust gas is primarily blocked by the left pipe 20 and the right pipe 22 formed of a first heat resistant material so that high heat from exhaust does not come into direct contact, and high heat is secondarily blocked by a heat blocking fiber that is a heat blocking material, so that the resistance against oxidation of the bellows pipe is strengthened and the durability thereof can easily be secured.

For convenience in explanation and accurate definition in the appended claims, the terms front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust gas supply pipe for an exhaust gas recirculation (EGR) cooler of a vehicle, comprising:
a left pipe connected to an exhaust manifold of an engine;
a right pipe connected to an EGR cooler;
a bellows connecting the left pipe and the right pipe to each other and disposed at an outer periphery of the left pipe; and
a heat blocking material filled in a space between the outer periphery of the left pipe and an inner periphery of the bellows.

2. The exhaust gas supply pipe of claim 1, wherein the heat blocking material is as a heat blocking fiber made of silica.

3. The exhaust gas supply pipe of claim 1, wherein a rear end of the outer periphery of the left pipe and a front end of an outer periphery of the right pipe include a fastening end projecting therefrom over which both ends of the bellows are placed, respectively, and fastened by a clamp.

4. The exhaust gas supply pipe of claim 1, wherein a step is formed in a front end of the inner periphery of the right pipe such that a front end of the left pipe is slid and inserted therein.
